(19) United States
(12) Patent Application Publication
(10) Pub. No.: US 2016/0200219 A1
(43) Pub. Date: Jul. 14, 2016

(54) Vehicle Occupant Presence and Reminder System

(71) Applicant: Hokky Tjahjono, Fort Worth, TX (US)

(72) Inventor: Hokky Tjahjono, Fort Worth, TX (US)

(21) Appl. No.: 14/857,872

(22) Filed: Sep. 18, 2015

Related U.S. Application Data
(63) Continuation-in-part of application No. 14/591,942, filed on Jan. 8, 2015, now abandoned.

(51) Int. Cl. B60N 2/00; G01K 3/08; G01P 15/00; G01J 5/10; G01S 19/13; B60Q 9/00

(52) U.S. Cl. CPC B60N 2/002; G01S 19/13; B60Q 9/00; G01P 15/00; G01J 5/10; G01K 3/08; G01J 2005/0077

(57) ABSTRACT

A warning system for detecting the presence of occupants and identifying emergency situations within a vehicle. The system utilizes an integrated pressure sensor to determine if a passenger is present in the vehicle; the integrated pressure sensor is positioned adjacent to a sitting surface of a passenger seat. A temperature sensor is used to determine the temperature the vehicle to be used for the identification of an emergency situation. The system also includes an external server, a wireless communication device, and a global positioning system (GPS) device. Information regarding the environment inside the vehicle is sent to the external server by the wireless communication device. The external server analyzes said information in order to identify the emergency situation. If the emergency situation is identified, then a location of the vehicle is obtained from the GPS device and is sent to the proper authorities along with a sign for help.

The current application is a continuation-in-part (CIP) application of a U.S. non-provisional application Ser. No. 14/591,942 filed on Jan. 8, 2015, and a continuation-in-part (CIP) application of a U.S. non-provisional application Ser. No. 14/857,868 filed on Sep. 18, 2015.

### FIELD OF THE INVENTION

The present invention relates generally to a method for a vehicle-integrated reminder system for occupant presence. More specifically, the present invention is a method for detecting the presence of vehicle occupants, determining internal conditions of said vehicle, and notify the proper authorities in the case an emergency situation is identified based on the aforementioned information.

### BACKGROUND OF THE INVENTION

Every year dozens of children die from heat stroke as a result of being left alone in hot cars. Resultantly, more than 600 children have died in the U.S. since 1990. These incidents are the result of parents leaving children alone in cars where temperatures reach dangerous, even fatal, limits in a short amount of time. When left in the sun, automotive vehicles act similar to glass greenhouses; the windows allows the sun to heat up the car's interior while simultaneously prevent the resultant heat from escaping, thus increasing the temperature inside the car at a rapid rate. Compared to adults, children's bodies produce relatively greater amount of heat and cool off at a slower rate, thus increasing the chances for heat stroke. Heat stroke is form of hyperthermia that is characterized by the failure of the body's temperature-regulating mechanisms due to exposure to high temperatures. Heat stroke can cause heat cramps, heat syncope, heat exhaustion, and damage to the brain and other internal organs. In more severe cases, heat stroke can kill. This is why leaving a child in a hot car, even for a short period of time, is extremely dangerous. Currently, the only attempt at solving this problem has been increasing awareness.

The present invention provides an active solution to the aforementioned problem. The present invention is a method for an alert and reminder system for vehicle occupants. The system detects the presence of a vehicle occupant through the use of a pressure sensor and alternative peripheral devices. If an occupant is detected, the system determines if the environment inside the vehicle is dangerous to the health of the occupant through the analysis of internal temperature readings, external weather and temperature conditions, humidity levels, and other relevant environmental conditions. In the case that a dangerous environment is determined, the system sends out multiple emergency notifications to various individuals and entities including the police and fire departments.

### BRIEF DESCRIPTION OF THE DRAWINGS

FIG. 1 is a flow chart depicting a portion of the overall process for the method of the present invention.

FIG. 2 is a flow chart depicting a portion of the overall process for the method of the present invention.

FIG. 3 is flow chart for the method of the present invention, depicting the steps necessary to activate an integrated pressure sensor.

FIG. 4 is a flow chart for the method of the present invention, depicting the components and steps necessary to send a plurality of environmental conditions to an external server for analyzing.

FIG. 5 is a flow chart for the method of the present invention, depicting the steps necessary to record and analyze a temperature reading within an automotive vehicle through an at least one temperature sensor.

FIG. 6 is a flow chart for the method of the present invention, depicting the steps necessary to record and analyze a temperature rate-of-change value within an automotive vehicle through the at least one temperature sensor.

FIG. 7 is a flow chart for the method of the present invention, depicting the steps necessary to record and analyze the temperature reading within the automotive vehicle through a thermographic camera.

FIG. 8 is a flow chart for the method of the present invention, depicting the steps necessary to record and analyze the temperature rate-of-change value within the automotive vehicle through the thermographic camera.

FIG. 9 is a flow chart for the method of the present invention, depicting the steps necessary to record and analyze a humidity reading within the automotive vehicle through a hygrometer.

FIG. 10 is a flow chart for the method of the present invention, depicting the steps necessary to generate and send real-time updated notifications through the wireless communication device.

FIG. 11 is a flow chart for the method of the present invention, depicting the steps necessary to identify a location of the automotive vehicle and integrated the location into an initial emergency notification.

FIG. 12 is a flow chart for the method of the present invention, depicting the steps necessary to obtain a weather forecast for the location of the automotive vehicle and integrate the weather forecast into the initial emergency notification.

FIG. 13 is a flow chart for the method of the present invention, depicting the steps necessary to record a plurality of images and integrate the plurality of images into the initial emergency notification.

FIG. 14 is a flow chart for the method of the present invention, depicting the steps necessary to alter the monitoring frequency of the present invention in response to a movement notification.

FIG. 15 is a flow chart for the method of the present invention, depicting a plurality of safety responses for the emergency situation as well as the steps necessary to execute each of the plurality of safety responses.

FIG. 16 is a flow chart for the method of the present invention, depicting a proper response from the plurality safety responses, starting an engine of the automotive vehicle.

FIG. 17 is a flow chart for the method of the present invention, depicting a proper response from the plurality safety responses, activating an air conditioning system of the automotive vehicle.

FIG. 18 is a flow chart for the method of the present invention, depicting a proper response from the plurality safety responses, actuating an at least one window actuation module.

FIG. 19 is a flow chart for the method of the present invention, depicting a proper response from the plurality safety responses, activating an at least one door locking mechanism of the automotive vehicle.

FIG. 20 is a flow chart for the method of the present invention, depicting a proper response from the plurality safety responses, activating a horn of the automotive vehicle.

FIG. 21 is a sectional schematic diagram of the system of the present invention, in particular the integrated embodiment of the present invention.

FIG. 22 is a sectional schematic diagram of the system of the present invention, in particular the retrofit embodiment of the present invention.

FIG. 23 is an electronic schematic diagram for the system of the present invention.

FIG. 24 is an electric schematic diagram for the system of the present invention.

### DETAIL DESCRIPTIONS OF THE INVENTION

All illustrations of the drawings are for the purpose of describing selected versions of the present invention and are not intended to limit the scope of the present invention.

The present invention is a warning and alert system which detects occupants and emergency conditions within an automotive vehicle and responds accordingly. More specifically, the present invention is a method and system which detects the presence of occupant(s) within the automotive vehicle, determines if the environmental conditions within the vehicle are dangerous to said occupant(s), and responds accordingly. The system of the present invention includes a plurality of environment sensing devices which monitors the internal environment conditions of the automotive vehicle as well as the necessary electronic components required to analyze and process the gathered information. The method of the present invention uses the information obtained by the plurality of environment sensing devices to determine if an occupant is present and if he/she is an emergency situation, i.e. a dangerous environment. If the occupant is in an emergency situation, the present invention sends an alert notification to emergency authorities and a plurality of contacts; the alert notification includes descriptive information relating to the emergency situation such as type of situation and a location of the automotive vehicle. One of the main applications of the present invention is in relation to children and infants in automotive vehicles. In particular, the present invention is used to prevent children and infants from being left unattended in an automotive vehicle in order to prevent heat injury, i.e. heat stroke.

The present invention is integrated into an automotive vehicle 1. The present invention may be integrated into different types of automotive vehicles including, but not limited to, sedans, minivans, trucks, limousines, and vans. The present invention may be implemented in two main forms, an integrated embodiment and a retrofit embodiment. In the integrated embodiment, the system of the present invention is integrated into the automotive vehicle 1 during the design and manufacturing processes. In the retrofit embodiment, the system of the present invention is a retrofit apparatus that is installed into the automotive vehicle 1.

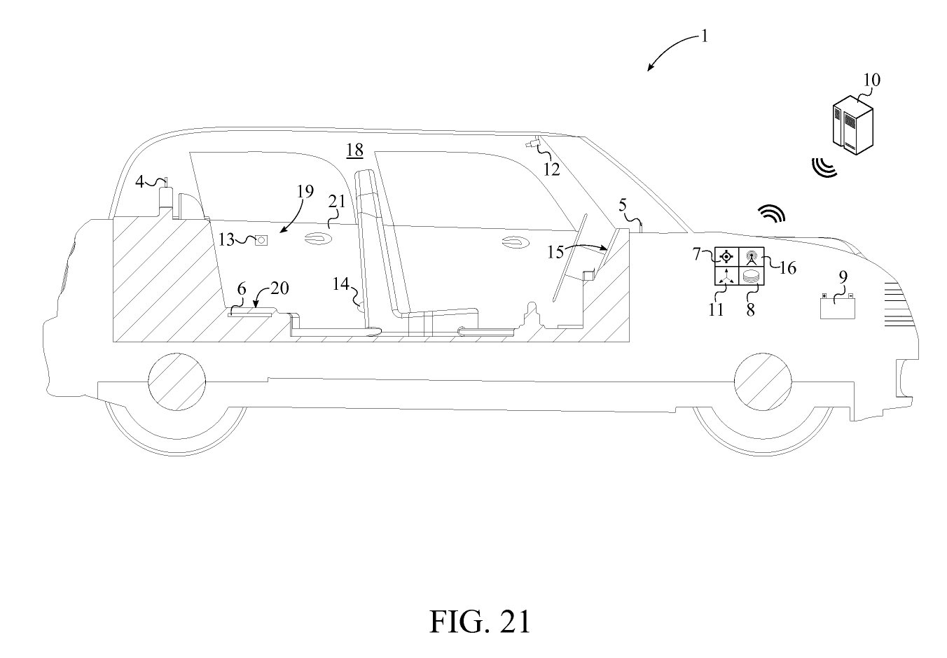

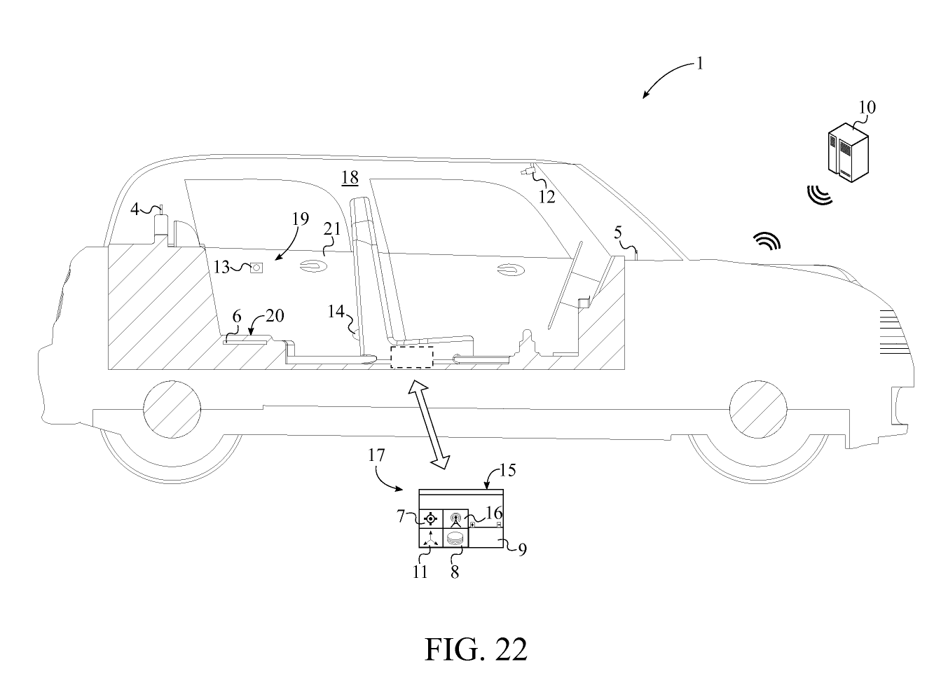

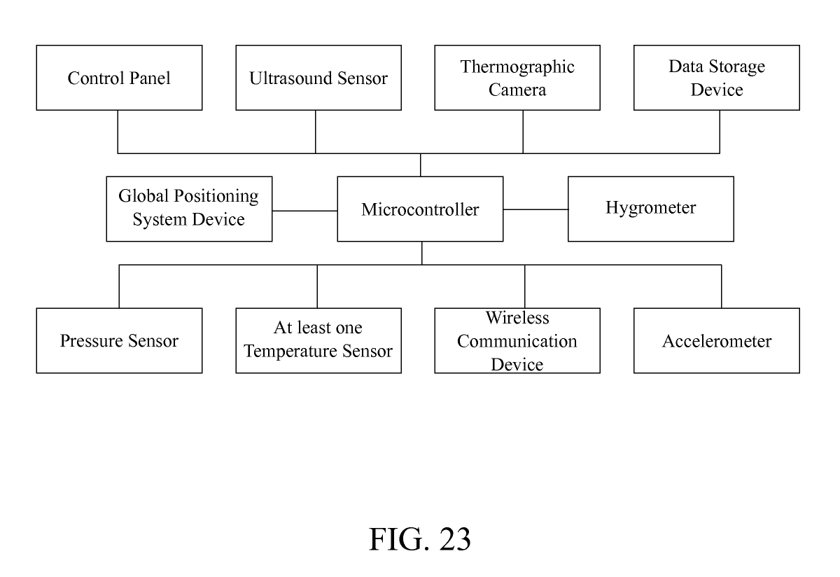

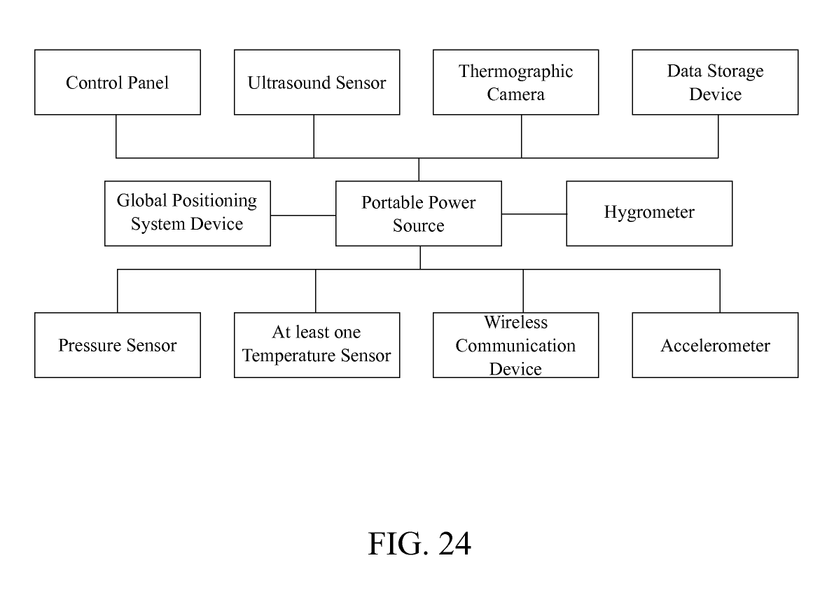

Referring to FIG. 21 and FIG. 22, in general the system of the present invention includes a portable power source 9, a microcontroller 2, an at least one temperature sensor 3, an integrated pressure sensor 6, a global positioning system (GPS) device 7, an external server 10, and a wireless communication device 8. The microcontroller 2, the GPS device 7, the portable power source 9, and the wireless communication device 8 are each positioned within the automotive vehicle 1. The portable power source 9 provides the necessary electric energy for the present invention and, thus, is electrically connected to the microcontroller 2, the at least one temperature sensor 3, the integrated pressure sensor 6, the GPS device 7, and the wireless communication device 8 as seen in FIG. 24. Various types of devices may be used for the portable power source 9, although a rechargeable battery is the preferred device. In the integrated embodiment, the present invention draws the required electric energy from the internal battery of the automotive vehicle 1. The microcontroller 2 manages the flow of data to, from, and in between the components of the present invention; essentially controlling the actions and settings of the components. More specifically, the microcontroller 2 is electronically connected to the at least one temperature sensor 3, the integrated pressure sensor 6, the GPS device 7, and the wireless communication device 8 as seen in FIG. 23. In one embodiment, the microcontroller 2 is additionally electronically connected to an onboard computing system of the automotive vehicle 1 such that the present invention may utilize information collected by the automotive vehicle 1. The at least one temperature sensor 3 includes a first temperature sensor 4 that is mounted within a cabin 18 of the automotive vehicle 1; the at least one temperature sensor 3 is one of the plurality of environment sensing devices. The first temperature sensor 4 measures the internal ambient temperature of the cabin 18. The first temperature sensor 4 is preferably positioned adjacent to a passenger seat 19 of the automotive vehicle 1 in order to obtain a more accurate temperature reading around an occupant of the passenger seat 19. The temperature reading is used to determine if the occupant is in a dangerous environment as temperatures outside a specific temperature range are harmful to the human body. In an alternative embodiment, the at least one temperature sensor 3 also includes a second temperature sensor 5. The second temperature sensor 5 is be used to obtain additional temperature readings of the cabin 18 as a redundancy feature in case the first temperature sensor 4 fails; the second temperature sensor 5 is also internally mounted within the cabin 18, electronically connected to the microcontroller 2, and electrically connected the portable power source 9.

The integrated pressure sensor 6 is positioned adjacent to a sitting surface 20 of the passenger seat 19 and is used to determine the presence of the occupant. In particular, the presence of the occupant is determined if a pressure reading from the integrated pressure sensor 6 is greater than a pre-defined limit. When the occupant is identified, the present invention begins to monitor the internal environment conditions at an increased frequency. The wireless communication device 8 is positioned within the automotive vehicle 1 and allows for wireless data transmission between the microcontroller 2 and the external server 10 as well as other external entities, i.e. emergency authorities. In particular, the wireless communication device 8 is communicably coupled to the external server 10, allowing information gathered by the plurality of environment sensing devices to be transmitted to the external server 10. In one embodiment, the system utilizes a subscriber identity module (SIM) in order to be compatible with local wireless networks. One of the more important pieces of information transmitted to the external server 10 is the location of the automotive vehicle 1 as this is used to direct the emergency authorities to the automotive vehicle 1 in emergency situations. The location of the automotive vehicle 1 is determined by the GPS device 7. The external server 10 receives, processes, and analyzes information from the GPS device 7, the integrated pressure sensor 6, the first temperature sensor 4, and other environmental sensing devices in order to identify emergency situations, the presence of occupant(s), and in emergency situations notify external entities.

The system may also utilize additional components to enhance the aforementioned components and to obtain additional information relating to the environmental conditions within the automotive vehicle 1. Additional components include, but are not limited to, an accelerometer 11, a thermographic camera 12, a hygrometer 13, a control panel 15, a data storage device 16, a microphone, a camera, and a speaker. The accelerometer 11, the thermographic camera 12, the hygrometer 13, the ultrasound sensor 14, the control panel 15, and the data storage device 16 are each electrically connected to the portable power source 9 and are each electronically connected to the microcontroller 2. The portable power source 9 powers the aforementioned components while the microcontroller 2 gathers and process data from the components as mentioned above. The accelerometer 11 is mounted within the automotive vehicle 1 and measures the acceleration of the automotive vehicle 1. The relative movement of the automotive vehicle 1 in conjunction with the pressure reading are used to set an alert state for the present invention, further described below. The thermographic camera 12 is pivotably mounted within the cabin 18 and is preferably oriented towards the passenger seat 19. The thermographic camera 12 provides a constant stream of infrared images that are used to determine the temperature within the automotive vehicle 1. The temperature obtained by the thermograph validates the temperature readings from the first temperature sensor 4 and the second temperature sensor 5. Additionally, the thermographic camera 12 may also be used to validate the presence of the occupant. The hygrometer 13 is mounted within the cabin 18, adjacent to the passenger seat 19, and is used to obtain a humidity reading within the automotive vehicle 1. The humidity reading in conjunction with the temperature reading are used to determine if the environment conditions are dangerous to the occupant(s) as high humidity environments apply additional stress on the human body, especially in high temperature environments.

The camera is mounted within the cabin 18 and is used to provide the plurality of contacts with additional information about the interior of the automotive vehicle 1 through still images or a continuous video stream. The microphone and speaker are mounted within the cabin 18 and may be used by the occupant(s) to call and connect with the plurality of contacts.

The control panel 15 is internally mounted within the cabin 18 and acts as a user interface, allowing a user to manually control the present invention; the control panel 15 is mostly used during the installation processes in order to calibrate and properly install the plurality of environments sensing devices. The preferred control panel 15 is integrated into a touchscreen of the automotive vehicle 1, allowing for customization of the user interface. The data storage device 16 is mounted within the automotive vehicle 1 and is used to store information collected by the present invention to act as a black-box. Information stored on the data storage device 16 may later be used to determine patterns and habits of the user in order to customize and individualize the present invention to said user. For example, the driving habits of the user can be used to determine when possible emergency situations may occur.

In the retrofit embodiment, seen in FIG. 22, the system of the present invention also includes a portable enclosure 17 and an ultrasound sensor 14. The portable enclosure 17 is internally mounted within the automotive vehicle 1 and acts as a physical housing for some of the constituents of the present invention. More specifically, the microcontroller 2, the GPS device 7, the wireless communication device 8, and the portable power source 9 are mounted within the portable enclosure 17. Additionally for the retrofit embodiment, the control panel 15 is externally mounted to the portable enclosure 17. The preferred location of the portable enclosure 17 is directly under the passenger seat 19 and out of sight, although alternative locations may also be utilized. The ultrasound sensor 14 is mounted within the cabin 18, oriented towards a door 21 of the automotive vehicle 1. The ultrasound sensor 14 is used to determine the status of the door 21, whether it is open or closed. The ultrasound sensor 14 is electronically connected to the microcontroller 2 and is electrically connected to the portable power source 9. It is preferred that a multitude of ultrasound sensors 14 be used, each oriented towards a specific door of the automotive vehicle 1. Alternatively, in the integrated embodiment of the present invention, the status of each door 21 is obtained from the onboard computer of the automotive vehicle 1.

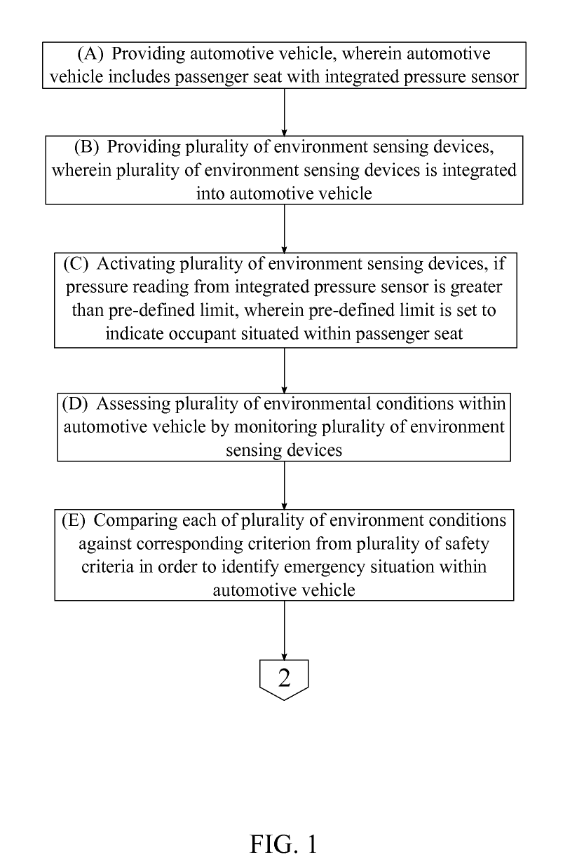

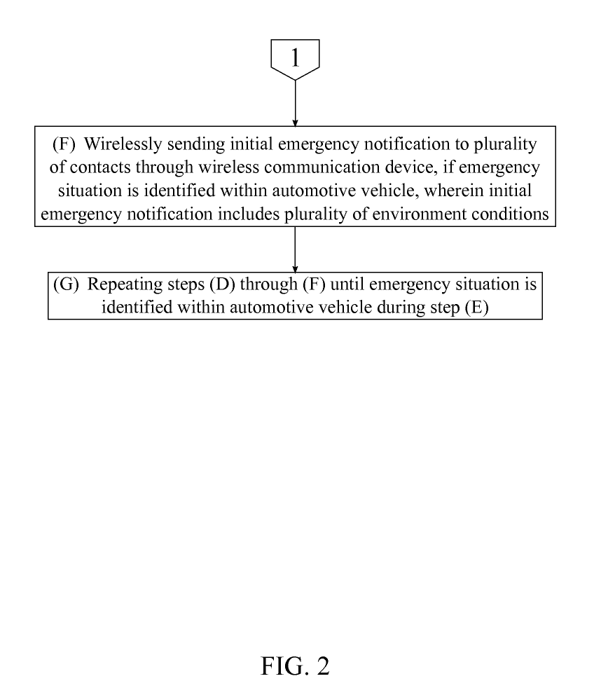

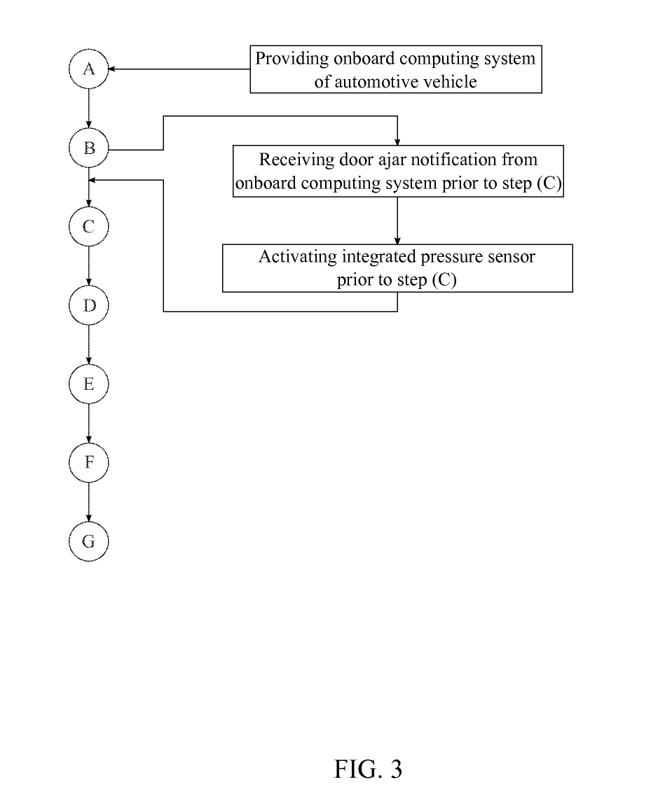

Referring to FIG. 1 and FIG. 2, the method of the present invention delineates the steps necessary to utilize the constituents of the system in order to monitor and analyze the internal environment of the automotive vehicle 1 as well as respond accordingly. The overall process beings with the activation of the integrated pressure sensor 6 in response to a door ajar notification; the door ajar notification is generated by the onboard computing system when the door 21 of the automotive vehicle 1 is opened, seen in FIG. 3. Alternatively, the door ajar notification may be generated by the ultrasonic sensor 14 of the system. Next, the plurality of environment sensing devices is activated in response to the integrated pressure sensor 6 measuring a pressure reading that is greater than a pre-determined limit, indicating that an occupant is situated within the passenger seat 19 (Step C).

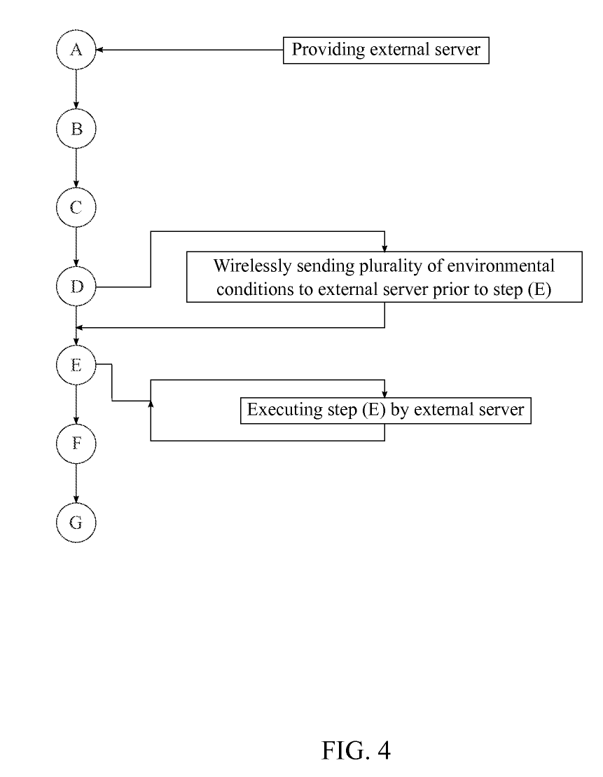

Next, the plurality of environment sensing devices begins to monitor the automotive vehicle 1 in order to acquire a plurality of environment conditions (Step D); the plurality of environment conditions includes information pertaining to the internal climate of the cabin 18, for example temperature and humidity. Additionally, the plurality of environment conditions depicts the operating status of the automotive vehicle 1, for example if the door(s) 21 and window(s) are open or closed. The plurality of environmental conditions is then wirelessly sent to the external server 10 for processing. The external server 10 compares each of the plurality of environment conditions against a corresponding criterion from a plurality of safety criteria in order to identify an emergency situation within the automotive vehicle 1 (Step E) as seen in FIG. 4. The plurality of safety criteria outlines the conditions under which the occupant(s) is safe while inside the automotive vehicle 1.

Continuing the overall process, if the emergency situation is identified within the automotive vehicle 1, then an initial emergency notification is wirelessly sent to a plurality of contacts through a wireless communication device 8; wherein the initial emergency notification includes the plurality of environment conditions (Step F). The plurality of contacts preferably includes emergency authorities such as a fire department, a police department, and the appropriate departments within a hospital. Additionally, the plurality of contacts may include relatives and other close personnel of the user/occupant(s); the plurality of contacts may be altered and customized to the preference of the user at any time. The initial emergency notification is a signal for help which includes the location of the automotive vehicle 1, obtained from the GPS device 7; this information is used to navigate the proper authorities to the automotive vehicle 1. If the emergency situation is not identified, then the system continuously repeats steps (D) through (F) until the emergency situation is identified within the automotive vehicle 1 during step (E) (Step G).

Two of the main criterion from the plurality of safety criteria is a safety temperature range and a temperature rate-of-change threshold. The safety temperature range defines a minimum limit and a maximum limit for the temperature within the cabin 18, outside of which the internal environment of the cabin 18 may become hazardous for the occupant(s). The preferred minimum limit is 55 degrees Fahrenheit and the preferred maximum limit is 99 degrees Fahrenheit, although alternative values may also be utilized as well. The temperature rate-of-change threshold defines a safe rate at which temperature may change within the cabin 18, anything greater is an indicator that the occupant(s) may soon be in a potentially hazardous environment. A rise in temperature at an abnormally fast pace will result in the cabin's 18 temperature reaching dangerous levels, quickly; hence, a temperature rate-of-change value is a valuable metric in identifying an emergency situation within the automotive vehicle 1. The preferred temperature rate-of-change threshold is one Fahrenheit degree per minute; although alternative rates may also be utilized.

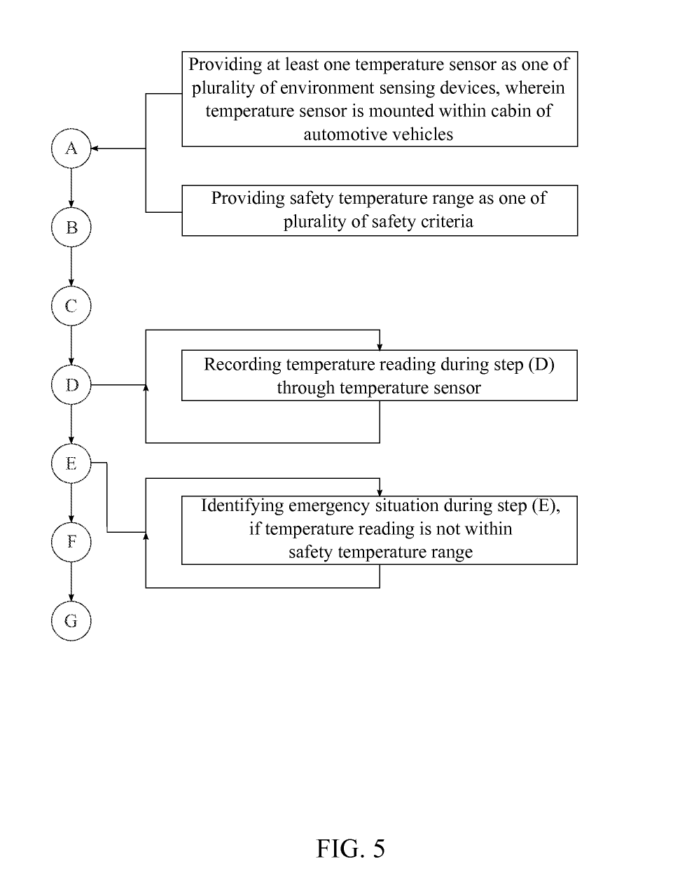

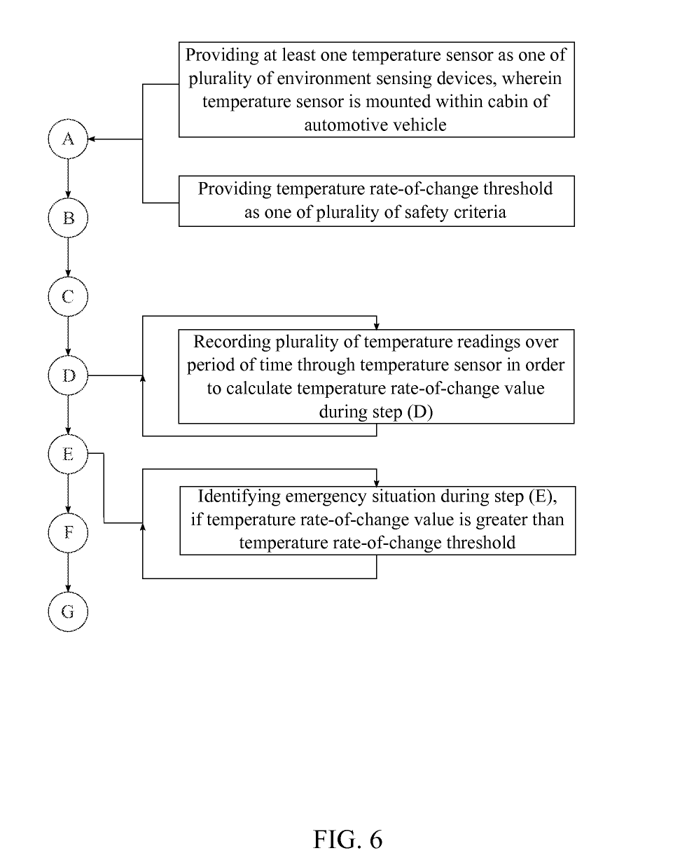

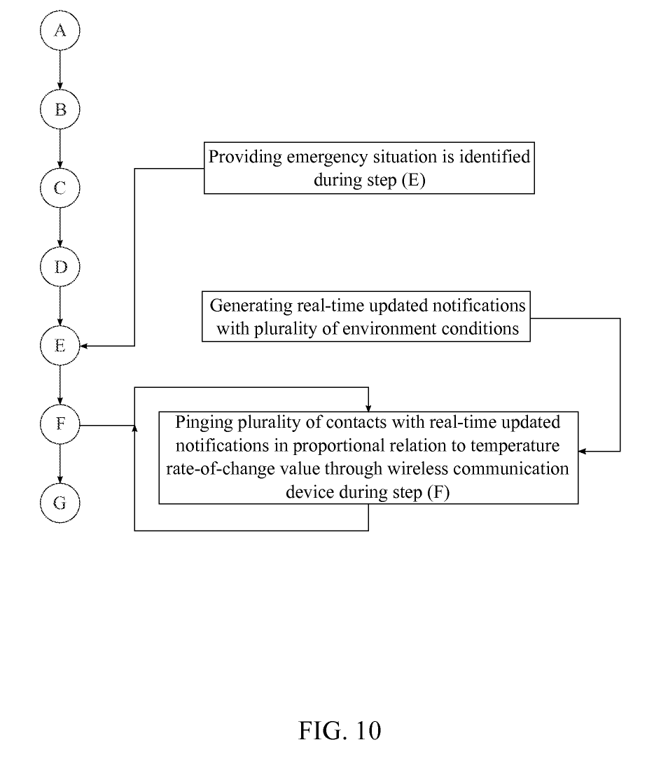

Referring to FIG. 5, the temperature reading is recorded during step (D) through the first temperature sensor 4 and or the second temperature sensor 5. If the temperature reading from either the first temperature sensor 4 or the second temperature sensor 5 is not within the safety temperature range, then an emergency situation is identified during step (E), resulting in the initial emergency notification being sent out to the plurality of contacts. Referring to FIG. 6, over a period of time the system records a plurality of temperature readings through the first temperature sensor 4 and or the second temperature sensor 5. The plurality of temperature readings is then used to calculate the temperature rate-of-change value during step (D), which in turn is then used to determine if the temperature is changing too quickly within the cabin 18. If the temperature rate-of-change value is greater than the temperature rate-of-change threshold, then the temperature is rising too quickly within the cabin 18 and the emergency situation is identified during step (E). In one embodiment, the system also generates additional real-time updated notifications with the plurality of environment conditions. The system then pings the plurality of contacts with the real-time updated notifications in proportional relation to the temperature rate-of-change value through the wireless communication device 8 during step (F) as seen in FIG. 10. A greater temperature rate-of-change value will result in the pings being sent at an increased frequency.

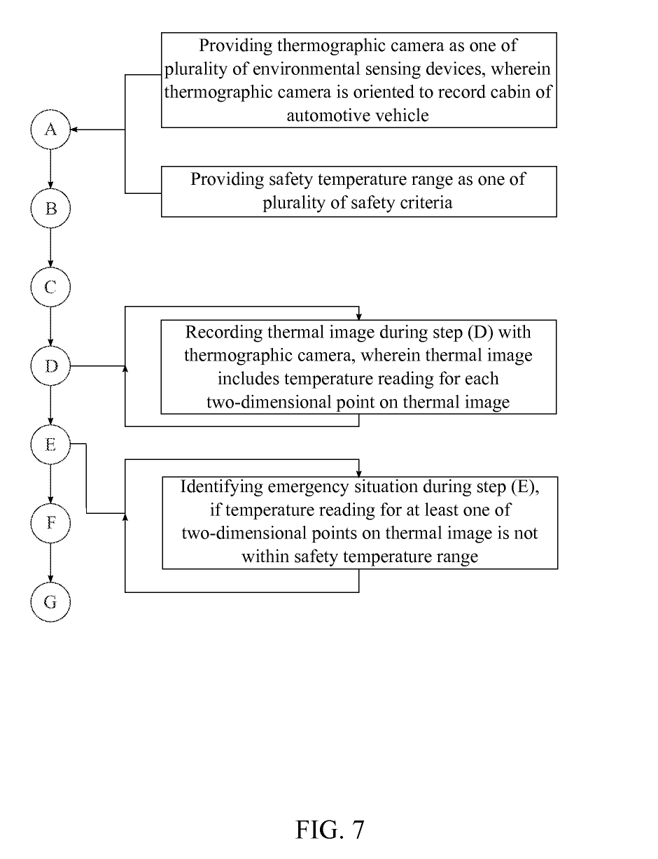

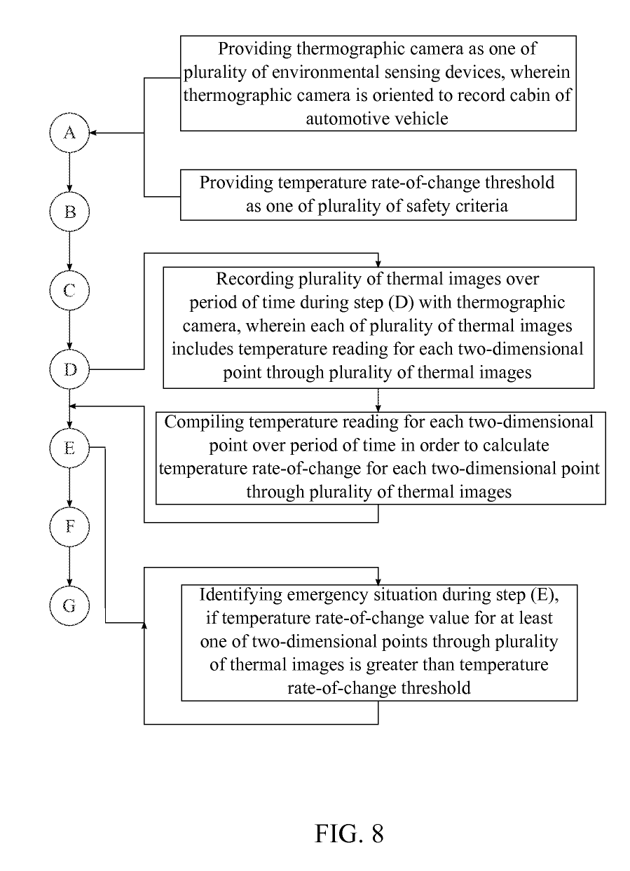

Referring to FIG. 7 and FIG. 8, in one embodiment of the present invention, the temperature reading and temperature rate-of-change value are obtained through the thermographic camera 12. In particular, the thermographic camera 12 records a thermal image during step (D) that includes a temperature reading for each two-dimensional point on the thermal image. Due to the natural high temperature of the human body, the thermal image must first be scanned and analyzed in order to exclude/ignore the temperature readings associated with the body of the occupant(s). This prevents the system from identifying the occupant body's heat as a possible dangerous environment, a false positive identification. In an alternative embodiment, the temperature readings associated with the body of the occupant(s) may be used to determine the health status of the occupant, a valuable metric for emergency authorities. This information may also be used to confirm the presence of the occupant(s) within the automotive vehicle 1. Temperature readings not associated with the occupant(s) are then analyzed against the safety temperature range. If the temperature reading for at least one of the two-dimensional points on the thermal image is not within the safety temperature range, then an emergency situation is identified during step (E). Similar to the first temperature sensor 4 and the second temperature sensor 5, over a period of time the thermographic camera 12 records a plurality of thermal images, during step (D). The temperature reading for each two-dimensional point over the period of time is then compiled in order to calculate a temperature rate-of-change value for each two-dimensional point. If the temperature rate-of-change for at least one of the two-dimensional points through the plurality of thermal images is greater than the temperature rate-of-change threshold, then an emergency situation is identified during step (E).

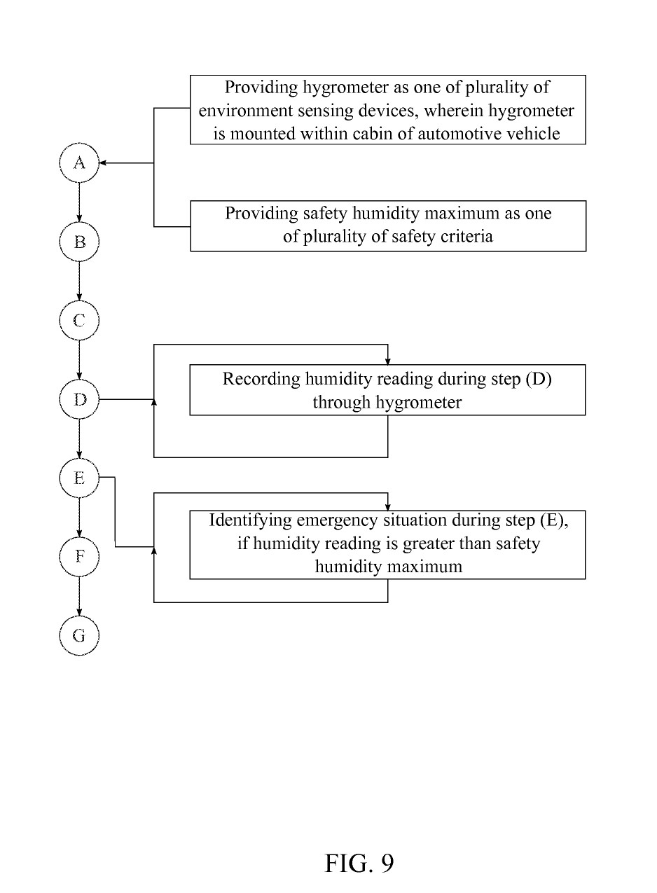

Referring to FIG. 9, another criterion from the plurality of safety criteria is a safety humidity maximum. The safety humidity maximum defines an upper limit on the humidity level allowable inside the cabin 18. The preferred safety humidity maximum is 50 percent as anything above causes discomfort to humans, even if the temperature is at a relatively comfortable level; alternative values may be used for the safety humidity maximum. A humidity reading is recorded through the hygrometer 13 during step (D) and if the humidity reading is greater than the safety humidity maximum, then an emergency situation is identified during step (E). Additionally, the present invention may also record a humidity rate-of-change during step (D) which may then be used to predict future humidity levels within the cabin 18. For example, if the humidity reading is greater than 50 percent and the humidity rate-of-change is greater than one percent per three minutes than the system identifies the environment inside the cabin 18 to be potentially hazardous, i.e. identifying an emergency situation during step (E).

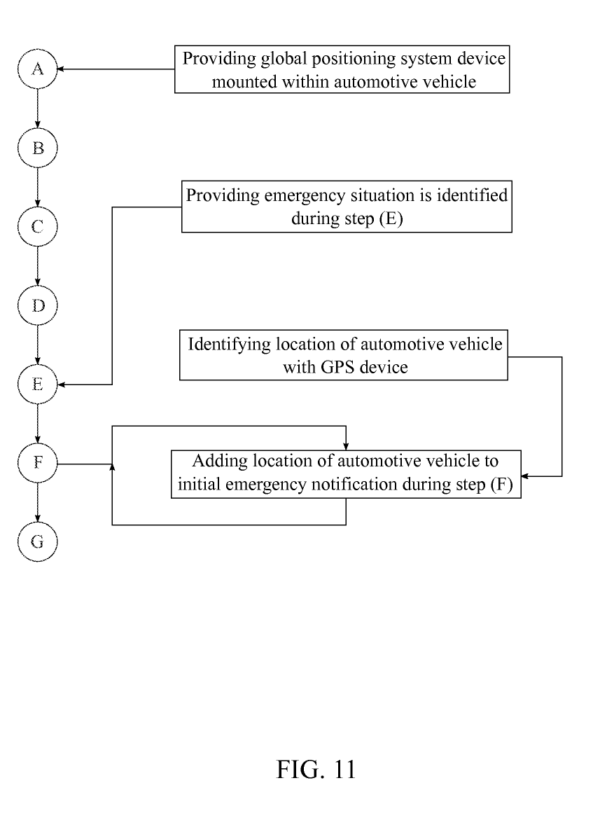

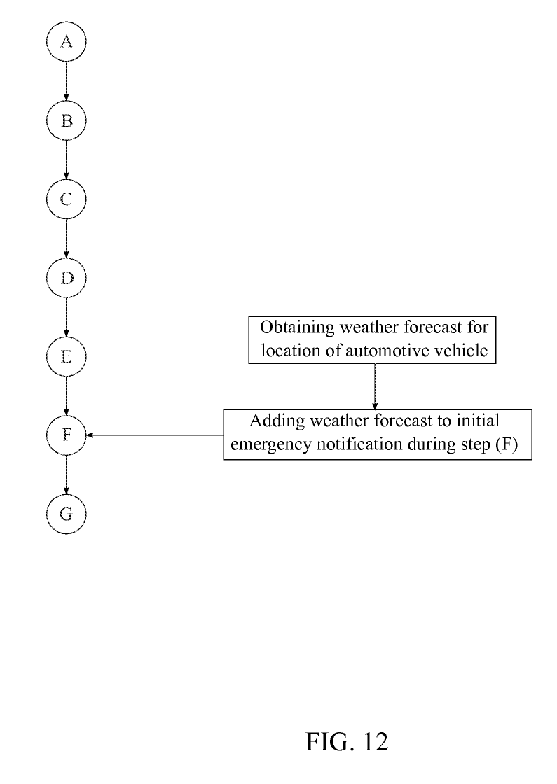

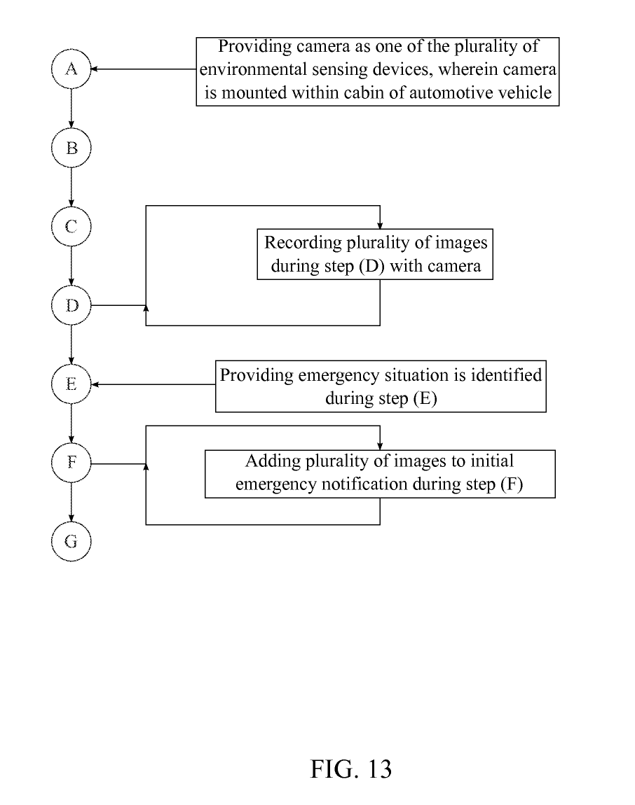

The initial emergency notification includes pertinent information about the status of the automotive vehicle 1 as well as the plurality of environment conditions. Information about the status of the automotive vehicle 1 includes, but is not limited to, door(s) 21 positioning, window(s) positioning, engine status, and other relevant data. One particularly important piece of data that is included in the initial emergency notification is a location of the automotive vehicle 1. Referring to FIG. 11, the location is identified by the GPS device 7 and added to the initial emergency notification during step (F). The plurality of environment conditions includes temperature readings, temperature rate-of-change values, humidity readings, and humidity rate-of-change values for a pre-defined time interval. Additionally, the plurality of thermal images and a plurality of images may also be included in the plurality of environment conditions. The plurality of thermal images is obtained from the thermographic camera 12. The plurality of images is obtained from the camera, depicted in FIG. 13. The camera records the plurality of images during step (D). The plurality of images provides the plurality of contacts with a visual representation of the cabin 18 and the occupants(s). In one embodiment, the external server 10 utilizes the location of the automotive vehicle 1 in order to obtain a weather forecast at said location and adds this information to the initial emergency notification as seen in FIG. 12. The weather forecast may be used to predict the temperature changes inside the cabin 18.

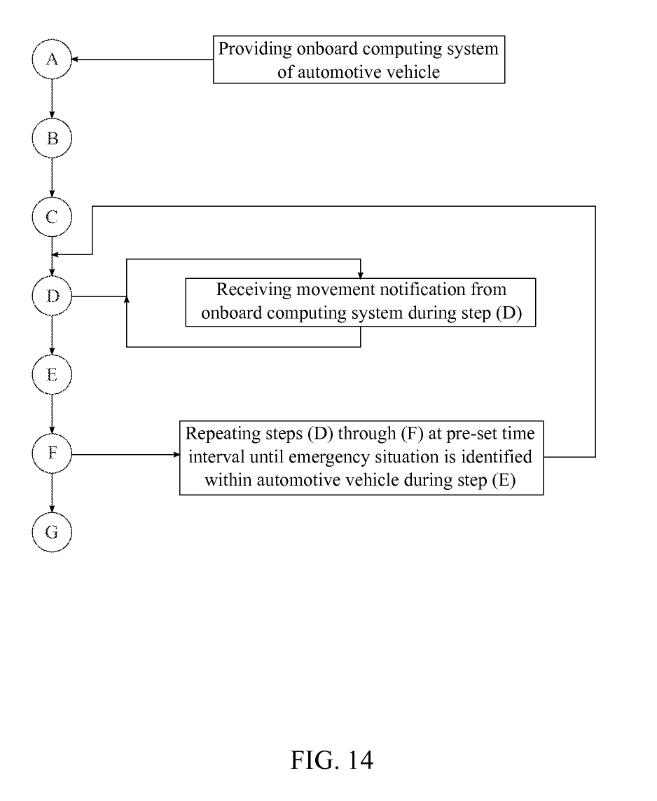

The system of the present invention may be set to a multitude of alert states, each associated with a specific situation. One specific situation includes the movement of the automotive vehicle 1. This specific situation is associated with any instances of the automotive vehicle 1 moving. Referring to FIG. 14, if the system receives a movement notification from the onboard computing system during step (D), then steps (D) and (F) are repeated at a pre-set time interval until the emergency situation is identified; the pre-set time interval denotes the frequency with which the plurality of environment sensing devices collect and record data.

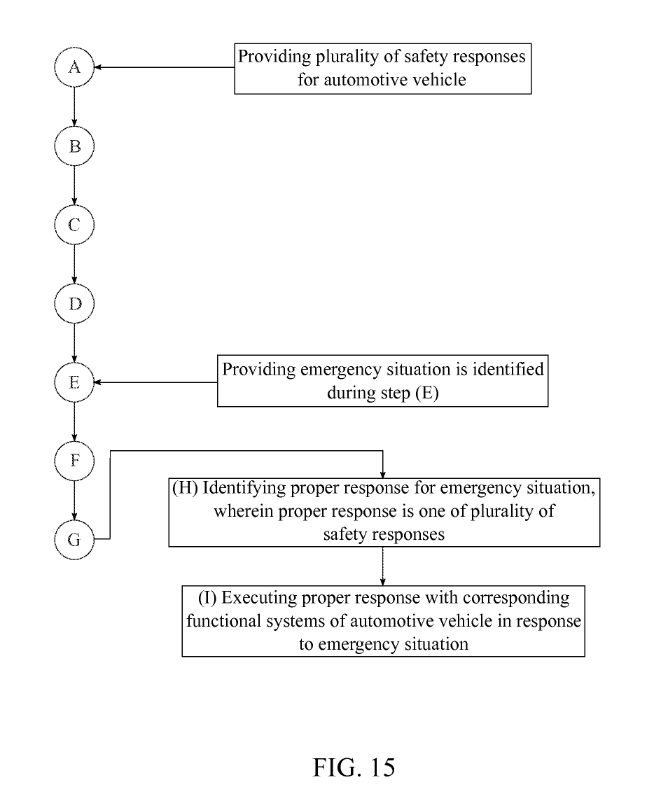

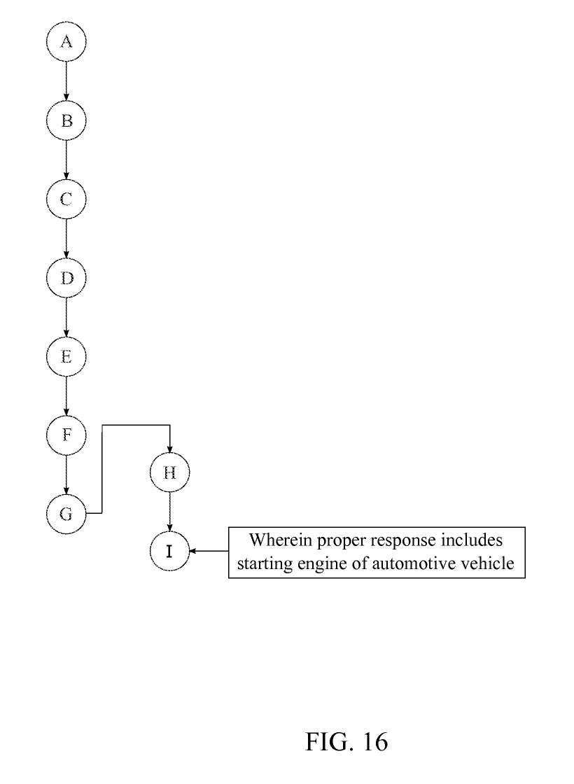

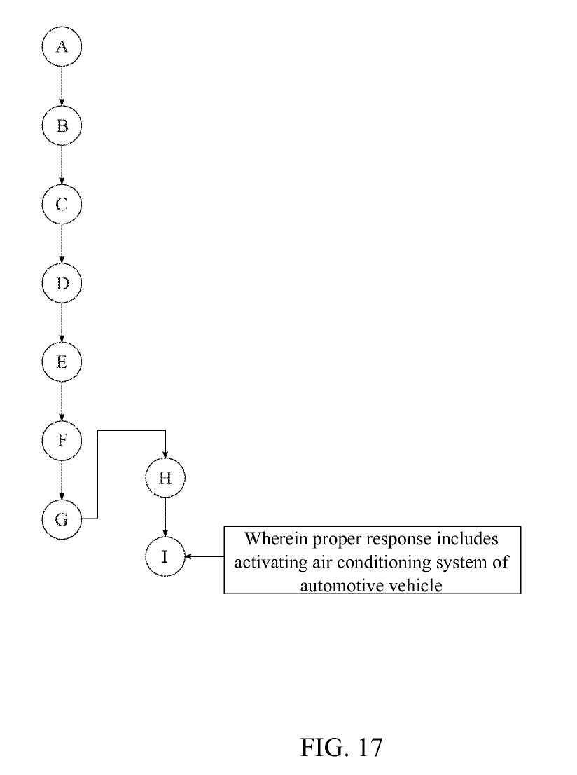

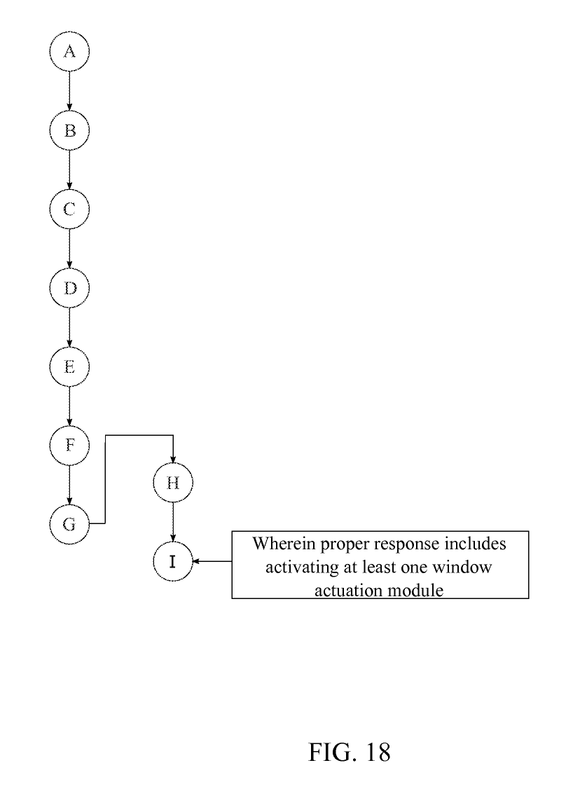

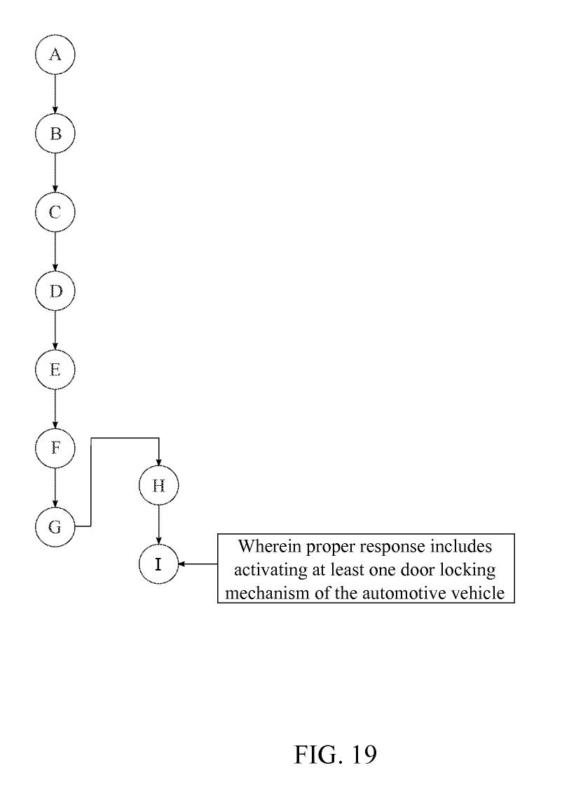

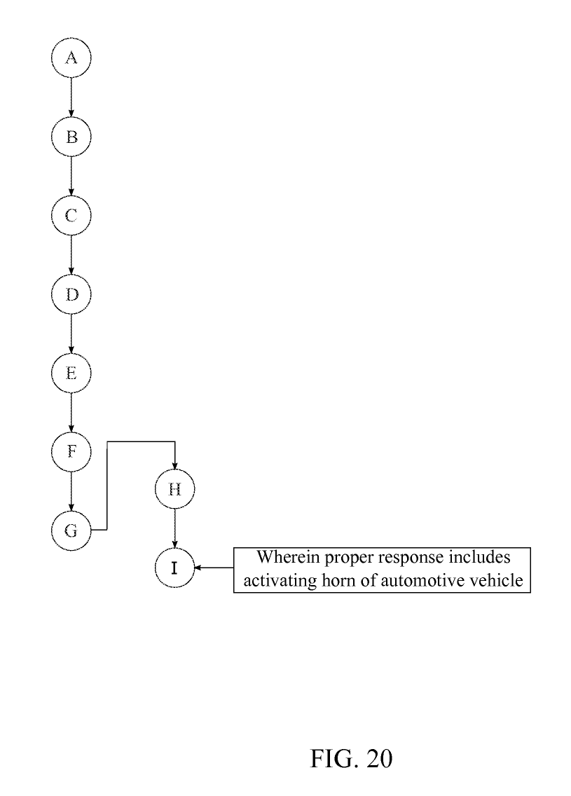

Referring to FIG. 15, in one embodiment, the present invention execute a plurality of safety responses when an emergency situation is identified. Once the emergency situation is identified, the system first identifies a proper response for the emergency situation, wherein the proper response is one of the plurality of safety responses. For example, if the temperature within the automotive vehicle 1 is above the maximum limit set forth by the safety temperature range, then the proper response includes procedures which will lower the temperature. Once the proper response is identified, the system executes said proper response with corresponding functional systems of the automotive vehicle 1. As seen in FIG. 16 through FIG. 20, included in the plurality of safety responses is starting an engine of the automotive vehicle 1; activating an air conditioning system of the automotive vehicle 1; activating an at least one window actuation module; activating an at least one door locking mechanism of the automobile vehicle; and activating a horn of the automotive vehicle 1.

The present invention may also contain a monitoring feature which allows the user to view the status of the automotive vehicle 1 and the cabin 18 remotely. This may be achieved through a website on the Internet or a software application on a mobile device. This feature allows the user to monitor the status of the automotive vehicle 1 in real-time.

Although the invention has been explained in relation to its preferred embodiment, it is to be understood that many other possible modifications and variations can be made without departing from the spirit and scope of the invention as hereinafter claimed.

What is claimed is:

1. A system for vehicle occupant presence and reminder system comprises:
an automotive vehicle;
a microcontroller;
an at least one temperature sensor;
an integrated pressure sensor;
a global positioning system (GPS) device;
a wireless communication device;
a portable power source;
an external server;
the external server being communicably coupled to the microcontroller by the wireless communication device;
the microcontroller, the at least one temperature sensor, the integrated pressure sensor, the GPS device, and the wireless communication device being electrically connected to the portable power source;
the microcontroller being electronically connected to the at least one temperature sensor, the integrated pressure sensor, the GPS device, and the wireless communication device;
the microcontroller, the portable power source, the GPS device, and the wireless communication device being positioned within the automotive vehicle;
the at least one temperature sensor being mounted within a cabin of the automotive vehicle, adjacent to a passenger seat of the automotive vehicle; and
the integrated pressure sensor being positioned adjacent to a sitting surface of the passenger seat.

2. The system for vehicle occupant presence and reminder system as claimed in claim 1 comprises:
an accelerometer;
the accelerometer being mounted within the automotive vehicle;
the accelerometer being electronically connected to the microcontroller; and
the accelerometer being electrically connected to the portable power source.

3. The system for vehicle occupant presence and reminder system as claimed in claim 1 comprises:
a thermographic camera;
the thermographic camera being pivotably mounted within the cabin;
the thermographic camera being oriented towards the passenger seat;
the thermographic camera being electronically connected to the microcontroller; and
the thermographic camera being electrically connected to the portable power source.

4. The system for vehicle occupant presence and reminder system as claimed in claim 1 comprises:
a hygrometer;
the hygrometer being mounted within the cabin, adjacent to the passenger seat;
the hygrometer being electronically connected to the microcontroller; and
the hygrometer being electrically connected to the portable power source.

5. The system for vehicle occupant presence and reminder system as claimed in claim 1 comprises:
an ultrasound sensor;
the ultrasound sensor being mounted within the cabin;
the ultrasound sensor being oriented towards a door of the automotive vehicle;
the ultrasound sensor being electronically connected to the microcontroller; and
the ultrasound sensor being electrically connected to the portable power source.

6. The system for vehicle occupant presence and reminder system as claimed in claim 1, wherein the at least one temperature sensor comprises a first temperature sensor and a second temperature sensor.

7. The system for vehicle occupant presence and reminder system as claimed in claim 1 comprises:
a control panel;
the control panel being internally mounted within the cabin;
the control panel being electronically connected to the microcontroller; and
the control panel being electrically connected to the portable power source.

8. The system for vehicle occupant presence and reminder system as claimed in claim 1 comprises:
a data storage device;
the data storage device being internally mounted within the automotive vehicle;
the data storage device being electronically connected to the microcontroller; and
the data storage device being electrically connected to the portable power source.

9. The system for vehicle occupant presence and reminder system as claimed in claim 1 comprises:
a portable enclosure;
the microcontroller, the GPS device, the wireless communication device, and the portable power source being mounted within the portable enclosure; and
the control panel being externally mounted to the portable enclosure.
